(19) United States
(12) Patent Application Publication
(10) Pub. No.: US 2025/0219305 A1
(43) Pub. Date: Jul. 3, 2025

(54) COAXIAL PORT TERMINATOR WITH BIASED RESISTOR PORTION CONFIGURED TO MITIGATE INTRODUCTION OF NOISE INTO A NETWORK

(71) Applicant: PPC BROADBAND, INC., East Syracuse, NY (US)

(72) Inventor: Jordan CAVINESS, Liverpool, NY (US)

(73) Assignee: PPC BROADBAND, INC., East Syracuse, NY (US)

(21) Appl. No.: 19/006,077

(22) Filed: Dec. 30, 2024

Related U.S. Application Data
(60) Provisional application No. 63/616,323, filed on Dec. 29, 2023.

(51) Int. Cl. H01R 9/05; H01R 13/24; H01R 13/631; H01R 24/42; H01R 103/00

(52) U.S. Cl. CPC H01R 9/0521; H01R 13/2442; H01R 13/6315; H01R 24/42; H01R 2103/00

(57) ABSTRACT

A male termination arrangement may include a body portion, a resistor portion structurally configured to be positioned within the body portion, and a floating portion structurally configured to be positioned within the body portion. The floating portion may be structurally configured to contact a biasing portion, the resistor portion may be structurally configured to connect to the floating portion, and the floating portion may be structurally configured to move within a floating cavity portion in response to external force to eliminate noise introduced to the resistor portion so as to mitigate noise introduced to a network to which the termination arrangement is connected.

### CROSS-REFERENCE TO RELATED APPLICATION

This application claims the benefit of U.S. Provisional Patent Application No. 63/616,323, filed on Dec. 29, 2023, the disclosure of which is hereby incorporated by reference herein in its entirety.

### TECHNICAL FIELD

The present disclosure is directed to a port termination adapter and, more particularly, to a system of terminating a coaxial port with a biased resistor portion configured to mitigate introduction of noise into a network.

### BACKGROUND

The proliferation of coaxial cabling to provide data and signal pathways has increased the need for cable interconnections with greater network distribution capabilities. To address such needs, network components often provide large numbers of available ports to allow a diverse array of connections and cabling connectivity. Over time, many cable ports can change status from used to unused, or vice-versa, as different network configurations, components, and/or sites are employed.

The presence of unused ports, particularly with ports configured for coaxial cable connectivity, can introduce noise and/or signal degradation characteristics to a cabling distribution network. For these reasons, it is a continued goal for cable networks, particularly coaxial cable networks, to terminate unused ports in a manner that preserves the performance and capabilities of an interconnected cabling network.

### SUMMARY

Embodiments provide a termination arrangement that includes a resistor pin portion that is structurally configured to contact a conductor aperture of a cable port to electrically terminate a cable conductor of the cable port via movement of a floating portion to mitigate noise introduced to a network to which the cable port is connected

Particular embodiments provide a termination arrangement structurally configured to electrically terminate a cable conductor, including: a body portion; a resistor pin portion positioned within the body portion; a resistor portion electrically connected to the resistor pin portion; a floating portion positioned within the body portion; and a fastening portion extending from the body portion. A biasing portion may be structurally configured to apply a force on the floating portion; the resistor portion may be partially contained within an internal cavity of the floating portion; the floating portion may be structurally configured with a first retention portion and a second retention portion respectively arranged to limit movement of the floating portion within a floating cavity of the body portion between thresholds along a longitudinal axis of the body portion; the first retention portion may be structurally configured to provide a first longitudinal threshold; the second retention portion may be structurally configured to provide a second longitudinal threshold; the floating portion may comprise a force protrusion structurally configured to attach to the biasing portion; the resistor portion may be structurally configured to have a larger cross-sectional area in a radial direction than a cross-sectional area of the resistor pin portion in the radial direction; the fastening portion may be structurally configured to physically secure the body portion to a cable port; the fastening portion may comprise a plurality of cantilevered protrusions each extending from the body portion and connected via a retention ring portion; the fastening portion may be structurally configured to physically secure to the cable port without rotation of the body portion relative to the cable port; the resistor pin portion may be structurally configured to contact the floating portion; and the resistor pin portion may be structurally configured to contact a conductor aperture of the cable port to electrically terminate a cable conductor of the cable port via movement of the floating portion to mitigate noise introduced to a network to which the cable port is connected.

According to various embodiments, the biasing portion may be structurally configured as a spring.

According to various embodiments, the resistor portion may be positioned in a resistor recess of the floating portion.

According to various embodiments, the second retention portion of the floating portion may be structurally configured as a ridge continuously extending around a periphery of the floating portion.

According to various embodiments, the first retention portion of the floating portion may be structurally configured as a cantilevered protrusion continuously extending around a periphery of the floating portion.

According to various embodiments, the body portion may comprise a protrusion that may be structurally configured to contact the floating portion second retention portion to limit movement of the floating portion relative to the body portion.

According to various embodiments, the body portion may be structurally configured to remain stationary during movement of the floating portion.

According to various embodiments, the respective cantilevered protrusions of the plurality of cantilevered protrusions may be structurally configured to be flexible relative to one another and relative to the body portion.

According to various embodiments, the plurality of cantilevered protrusions may define a retention contour portion.

According to various embodiments, the retention contour portion may be structurally configured as recesses into the respective cantilevered protrusions of the plurality of cantilevered protrusions.

According to various embodiments, the respective cantilevered protrusions of the plurality of cantilevered protrusions may be structurally configured with separation gaps continuously extending from the body portion.

Particular embodiments provide a coaxial termination arrangement including: a body portion; a resistor portion positioned within the body portion; a floating portion positioned within the body portion; and a fastening portion extending from the body portion. The floating portion may be configured to contact a biasing portion; the resistor portion may be physically connected to the floating portion; the floating portion may be structurally configured with a first retention portion and a second retention portion respectively arranged to limit movement of the floating portion within a floating cavity of the body portion; and the floating portion may be structurally configured to move within the floating cavity portion in response to external force to eliminate noise introduced to the resistor portion.

According to various embodiments, the body portion may be structurally configured to be physically attached to a port portion of a network component.

According to various embodiments, a resistor pin portion attached to the resistor portion may be structurally configured to fit within a cable port aperture.

According to various embodiments, the floating portion may be structurally configured to apply consistent physically pressure on the resistor portion to maintain the resistor pin portion in the cable port aperture.

According to various embodiments, the resistor portion may have a continuous resistance of 75 ohms.

According to various embodiments, the resistor portion may have a continuous resistance of 50 ohms.

According to various embodiments, the resistor pin portion may be structurally configured to electrically contact a signal carrying conductor of a cable.

Particular embodiments provide a male termination arrangement including: a body portion; a resistor portion positioned within the body portion; and a floating portion positioned within the body portion. The floating portion may be structurally configured to contact a biasing portion; the resistor portion may be physically connected to the floating portion; and the floating portion may be structurally configured to move within a floating cavity portion in response to external force to eliminate noise introduced to the resistor portion.

According to various embodiments, the floating portion may be structurally configured to move in response to the biasing portion to maintain the resistor portion in electrical contact with a cable conductor.

According to various embodiments, the floating portion may be structurally configured with a resistor recess portion shaped to center the resistor portion within the floating portion.

According to various embodiments, the resistor portion may be structurally configured to provide a constant resistance.

### BRIEF DESCRIPTION OF THE DRAWINGS

Further advantages and features of the present disclosure will become apparent from the following description and the accompanying drawings, to which reference is made.

FIG. 1 is a line representation of portions of a cable network in which assorted embodiments can be practiced.

FIG. 2 is a line representation of portions of a cable assembly that can be employed in the network of FIG. 1 in various embodiments.

FIG. 3 is a cross-sectional perspective view of portions of a port termination assembly that can be utilized in the network of FIG. 1 and the assembly of FIG. 2 in accordance with various embodiments.

FIG. 4 is a cross-sectional view of portions of a port termination assembly configured in accordance with various embodiments.

FIG. 5 is a partial cross-sectional perspective view of portions of a port termination system arranged in accordance with various embodiments.

### DETAILED DESCRIPTION

Embodiments force a resistor pin portion of a port termination assembly to contact a conductor aperture of a port to electrically terminate a cable conductor of the port to reduce or eliminate noise introduced to a network to which the port is connected.

Reference will now be made in detail to embodiments and methods of the present disclosure. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may vary. Furthermore, the terminology used herein is used only for the purpose of describing particular embodiments of the present disclosure and is not intended to be limiting in any way.

While cable ports can provide connectivity options and efficient interconnections, the presence of open, unused, and/or non-terminated cable ports can introduce signal degrading characteristics into a cable network. Various embodiments of the present disclosure are directed to an assembly that securely and efficiently terminates a coaxial cable port with a termination portion that moves and resists force from a spring to properly position a resistor in contact with the cable port, which prevents noise and other signal degrading issues from penetrating a cable network.

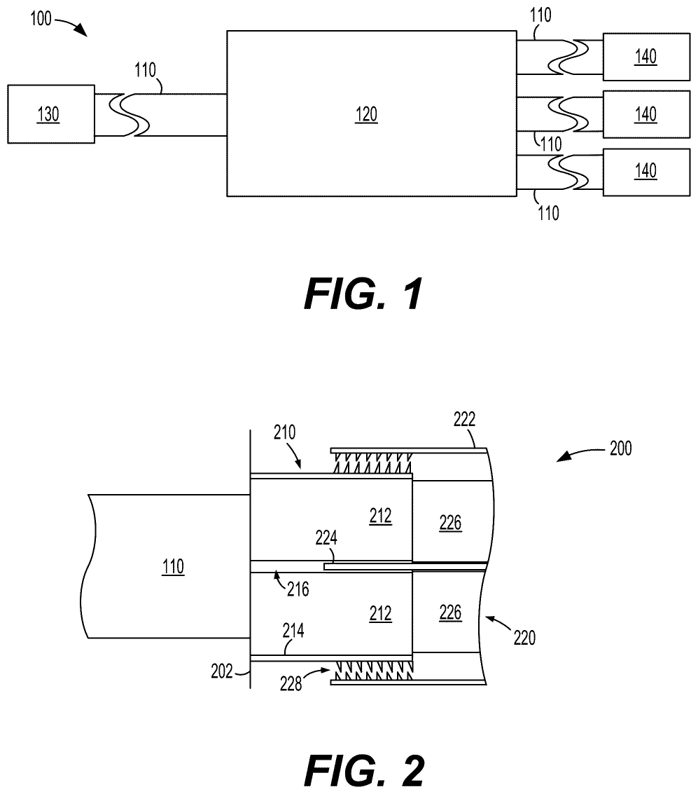

Turning to the drawings, FIG. 1 illustrates a line representation of an example cable network 100 that can utilize a port termination system in accordance with various embodiments. The cable network 100 can extend to any number of sites with one or more signal carrying cables 120 that employ at least one interconnect 120 to provide a continuous signal pathway from a signal source 130 to a signal destination 140. The non-limiting environment shown in FIG. 1 conveys how an interconnect 120 can connect multiple separate destinations 140 concurrently with separate cables 110.

A cable network 100 can employ any number, type, and length of cable 110 that provide a reliable signal pathway. For instance, a coaxial-type cable 110 can be employed that utilizes an electrical conductor while another cable 110 can be a fiber optic-type signal pathway. The ability to employ one or more interconnects 120 allows the cable network 100 to effectively join separate cables 110 with matching, or dissimilar, characteristics and/or capabilities to provide one or more stable and continuous signal pathways between source(s) 130 and destination(s) 140.

FIG. 2 illustrates a line representation of portions of a cable assembly 200 that can be utilized as part of the cable network 100 of FIG. 1. A cable 110 can extend through one or more barriers 202, such as a wall, sidewall, surface, or membrane, to provide a cable port 210. In some embodiments, the cable port 210 is an F-Type female connector that presents insulating material 212 within a chassis 214 to define a conductor aperture 216 that aligns with a conductor of the cable 110.

A connector 222 can engage the port 210 to insert a conducting pin 224 into the available aperture 216. It is contemplated that the connector 222 provides physical support with buffer portions 226 that contact aspects of the port 210 to ensure a reliable connection once the fastening mechanism 228 is fully utilized. As shown in FIG. 2, but not limiting to other configurations, the fastening mechanism 228 is arranged as a threaded engagement that selectively brings the conducting pin 224 into electrical contact with portions of the cable 110.

The port 210 may have a used or unused status. A used status can be characterized as connection of two separate cables 110 via the port 210 that physically aids in the electrical connection of conductors of the respectively connected cables 110, as illustrated in FIG. 1. An unused status can be characterized as not physically and electrically connected to another cable 110 and not providing a continuous signal pathway from one cable 110 to another cable 110. In the event the port 210 is unused, signal degradation in the cable 110, and corresponding network, can occur in the form of noise. That is, an unused port 210 can be a source of inadvertent noise that can degrade the quality, strength, and/or reliability of aspects of a cable network, particularly the cable 110 directly connected to the unused port 210.

Various embodiments contemplate mitigating the introduction of noise in unused network ports 210 by terminating the signal carrying conductor of the directly attached cable 110 with one or more electrical resistors. The physical incorporation of a resistor can occupy aspects of the buffer portions 226 and be wholly housed in the male F-type connector 222, in some embodiments. However, the formation of a reliable termination of a cable conductor via one or more resistors in the connector 222 can be difficult with a threaded fastening mechanism 228, as shown. For instance, terminating a cable conductor with a physically contacting resistor can rely on relatively precise resistor placement relative to the cable conductor, which can be challenging to provide by screwing the connector 222 onto the port chassis 214. As such, resistor installation with a threaded fastening mechanism 228 can be wrought with installation challenges and reliability issues over time.

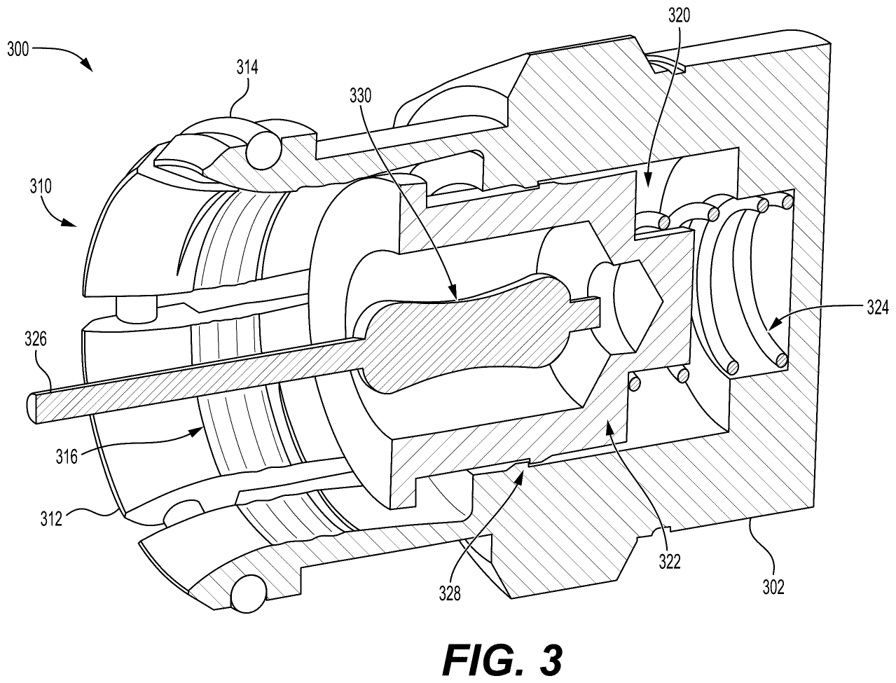

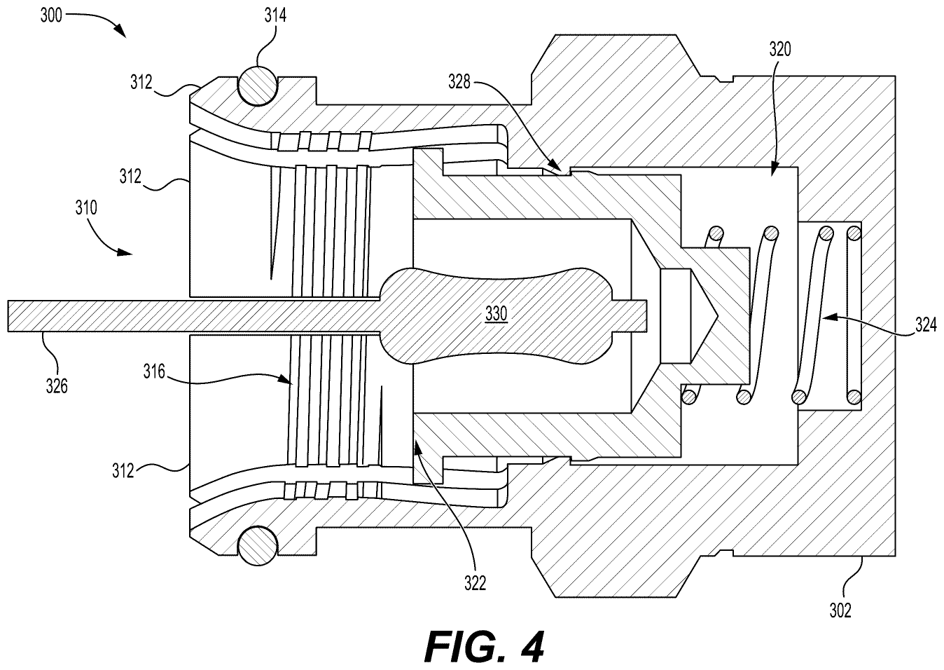

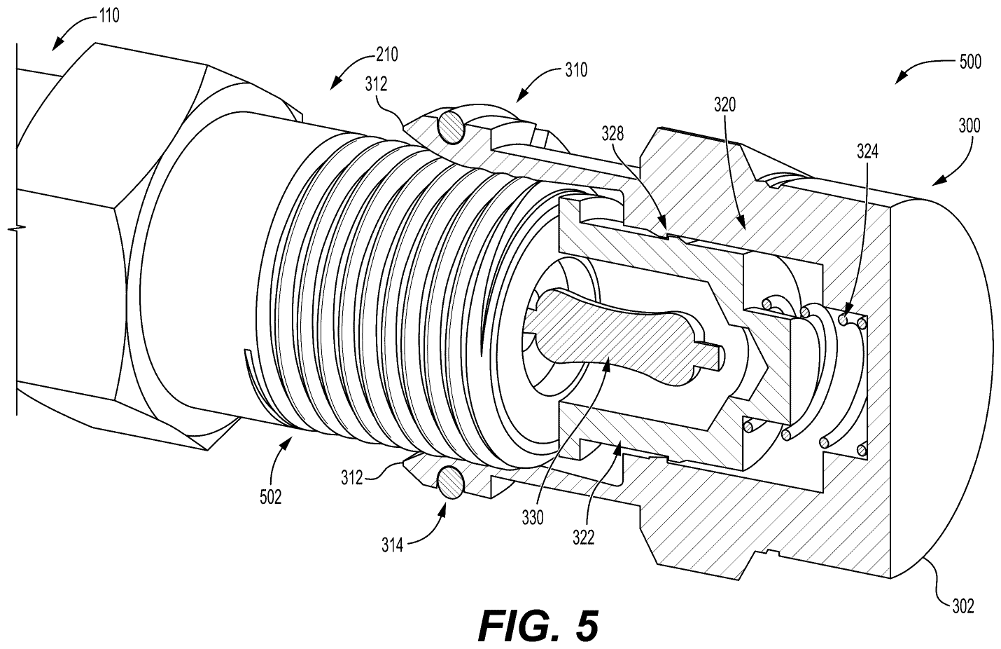

With the issues associated with unused ports 210 and electrically terminating a non-connected cable 110 in mind, various embodiments are directed to a termination system 500, as illustrated in FIG. 5, that utilizes a port termination arrangement, or assembly, 300 to efficiently and reliably terminate an unused port 210. FIGS. 3 and 4 respectively illustrate cross-sectional views that convey how assorted aspects of the port termination assembly 300 are arranged in accordance with some embodiments to provide efficient and reliable termination of a port 210.

The perspective view of FIG. 3 illustrates how a rigid body 302 is configured to provide a fastening portion 310 and a termination portion 320 that operate concurrently to physically engage a port 210 and electrically terminate a cable conductor directly attached to the port 210. The fastening portion 310 has several cantilevered protrusions 312 that are respectively separated radially by gaps that allow the protrusions 312 to independently move.

A continuous retention ring 314 surrounds the collective protrusions 312 and applies continuous force inward to allow each protrusion 312 to physically engage a port chassis 214 and retain the termination assembly 300 on the port 210, as shown in FIG. 5. The fastening portion 310 further has a retention contour 316 that provides varying topography in the form of one or more ridges, grooves, edges, and surfaces that can efficiently aid in the physical retention of the assembly 300 to the port by contacting the threaded fastening mechanism 228 of the port 210. It is noted that the retention contour 316 may, or may not, correspond to rotation of the assembly body 302 to fully install the assembly 300 on a port 210. In other words, the retention contour 316 can aid physical retention of the assembly 300 in a push-on manner or in a threaded connection.

In some embodiments, the retention contour 316 has the same pitch as the port threads, which can promote physical retention due to heightened surface area contact between the port 210 and fastening portion 310. Other embodiments of the retention contour 316 alter the configuration of the threads from the threads of the port 210 to provide bias retention force. For instance, one or more of the threads of the retention contour 316 can be angled with respect to the threads of the port 210 to make insertion of the fastening portion 310 on the port 210 easier than removal of the fastening portion 310 from the port. In other words, the retention contour 316 can be arranged to resist thread engagement in a first direction more than the opposite second direction, which promotes physical retention on the port 210 and resistance to the fastening portion 310 inadvertently backing off an installed location of the port.

The side view of FIG. 4 further illustrates how the fastening portion 310 can be arranged with a varying diameter, as measured between the protrusions 312. The non-limiting embodiment shown in FIGS. 3-5 convey how the fastening portion diameter reduces to a minimum distance near a front portion of the retention contour 316 before becoming wider by the rear portion of the retention contour 316. Such varying diameter can complement the configuration of the retention contour 316 to make insertion of the fastening portion 310 on the port 210 easier than removal. For clarification, the varying diameter of the fastening portion 310, as measured parallel to the transverse axis of the assembly 300, corresponds with a greater force needed to remove the fastening portion 310 from the threads of a port 210 than to install the fastening portion 310 onto the threads of the port 210.

The termination portion 320 has a floating portion 322 that engages a biasing portion, for example, a biasing 324, such as a spring, magnet, or other mechanism that applies continuous force, along an internal cavity of the assembly body 302. The internal cavity, as shown, has a second retention portion 328 that prevent the biasing 324 from moving the floating portion 322 beyond a predetermined threshold physical plane along the longitudinal axis of the termination assembly 300. A protruding flange aspect of the floating portion 322 further operates to limit the physical compression of the biasing 324 beyond another predetermined threshold. As such, the floating portion 322 is configured to move within the internal cavity and respond to external force imposed on the floating portion 322 by an encountered structure, such as the chassis 214 of a port 210.

The floating portion 322 controls the position of the resistor pin portion 326 that serves as an electrical resistor by physically occupying the conductor aperture 216 of a port 210, as shown in FIG. 5. The resistor pin portion 326 can be a variety of different shapes, sizes, and materials that effectively form an electrical resistor once contacting a cable conductor. The non-limiting embodiment of the resistor pin portion 326 shown in FIGS. 3 and 4 illustrate how aspects of the pin 326 are configured to electrically terminate a cable conductor and prevent signal noise from being introduced to the cable 110 directly attached to a port 210.

As shown in FIGS. 3-5, the resistor pin portion 326 is connected to a resistor portion 330 that provides a consistent electrical resistance, such as 75 ohms or 50 ohms, to terminate the electrical connection of the port 210. While the resistor portion 330 is shown as a continuous piece of material with the resistor pin portion 326, such construction is not required as the resistor portion 330 may be connected to the resistor pin portion 326 via a connection, such as a solder joint, metal sleeve, or both. For instance, the resistor pin portion 326 may be connected to an electrical resistor having a set resistance that is further electrically connected to the floating portion 322 proximal the biasing 324. That is, the resistor portion 330 may be electrically connected between the resistor pin portion 326 and the floating portion 322.

With the termination assembly 300 arranged to apply consistent force on the floating portion 322 to maintain the position, and electrical characteristics, of the resistor pin portion 326, the position of the assembly body 302 on a port chassis 214 is less critical to the proper termination of the port 210 than if the resistor was statically positioned. That is, the capability for movement of the floating portion 322 and consistent application of force by the biasing 324 allows the resistor pin portion 326 to be properly positioned relative to a port 210 to fully terminate a cable 110 in a range of assembly body 302 positions relative to the port chassis 214. As a result, the installation of the termination assembly 300 requires less depth precision and has greater depth tolerance than if the resistor pin portion 326 was statically positioned within the assembly body 302.

The plan cross-sectional view of FIG. 4 illustrates how the floating portion 322 engages the biasing 324 with a axially centralized protrusion, which aids in consistent alignment of force parallel the longitudinal axis of the floating portion 322, aligned with the longitudinal axis of the resistor pin portion 326, and along the central axis of the biasing 324. The physical limits to movement of the floating portion 322, along the longitudinal axis of the assembly body 302, further aids the proper positioning of the resistor pin portion 326 relative to a port's conductor aperture 216 without concern for installation error or inadvertent assembly 300 movement over time.

In operation, as generally illustrated in FIG. 5, the termination assembly 300 utilizes the fastening portion 310 to allow the assembly body 302 to push onto the threads 502 of the cable port 210 and engage the resistor pin portion 326 with the conductor aperture 216 of the port 210. Such push-on installation can be characterized as insertion of the resistor pin portion 326 and surrounding portions of the port 210 without rotating the assembly body 302. It is noted that the retention contour 316 of the fastening portion 310 can contribute to the efficient and secure physical engagement of the port threads 502.

Through the push installation of the termination assembly 300 onto the port 210, the port chassis 214 and/or insulation material 212 physically contact the floating portion 322, which translates force from the biasing 324 onto the assembly body 302 and fastening portion 310. The application of force onto the assembly body 302 in response to floating portion 322 contact with the port 210 resists further insertion of the termination assembly 300 onto/into the port 210. The ability of the floating portion 322 to move along the internal cavity of the assembly body 302 corresponds with proper positioning of the resistor pin portion 326, and complete electrical termination of the port 210, in a range of insertion depth of the assembly body 302 relative to the port 210. That is, the configuration of the termination portion 320 allows the resistor pin portion 326 to stay properly positioned to terminate the port 210 despite the assembly body 302 inserted in different depths around the port chassis 214.

It is contemplated that multiple different biasings 324 can concurrently operate on the floating portion 322 to provide a varying force profile as the floating portion 322 moves within the internal cavity. The use of the termination portion 320 allows for easier assembly 300 installation and higher retention on the port 210 than a port termination adapter that screws onto the port threads 502 and/or has a stationary electrical resistor. Consequently, the termination assembly 300 provides reliable electrical termination and robust resistance to varying installation depths along with changes in external forces and stresses incurred by the assembly body 302.

Also, with respect to the various embodiments of the present disclosure, the components of the cable 110 can be constructed of various materials which have some degree of elasticity or flexibility. The elasticity enables the cable 110 to flex or bend in accordance with broadband communications standards, installation methods or installation equipment. Also, the radial thicknesses of the cable 110, the signal pathway conductor 130, insulator 140, any shielding layers 150, and the outer jacket 160 can vary based upon parameters corresponding to broadband communication standards or installation equipment.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A termination arrangement structurally configured to electrically terminate a cable conductor so as to mitigate introduction of noise into a network, comprising:
a body portion;
a resistor pin portion structurally configured to be positioned within the body portion;
a resistor portion electrically connected to the resistor pin portion;
a floating portion structurally configured to be positioned within the body portion;
a fastening portion structurally configured to extend from the body portion;
wherein a biasing portion is structurally configured to apply a force on the floating portion;
wherein the resistor portion is structurally configured to be at least partially contained within an internal cavity of the floating portion;
wherein the floating portion is structurally configured with a first retention portion and a second retention portion respectively arranged to limit movement of the floating portion within a floating cavity of the body portion between thresholds along a longitudinal axis of the body portion;
wherein the first retention portion is structurally configured to provide a first longitudinal threshold;
wherein the second retention portion is structurally configured to provide a second longitudinal threshold;
wherein the resistor portion is structurally configured to have a larger cross-sectional area in a radial direction than a cross-sectional area of the resistor pin portion in the radial direction;
wherein the fastening portion is structurally configured to physically secure the body portion to a cable port;
wherein the fastening portion comprises a plurality of cantilevered protrusions each extending from the body portion and connected via a retention ring portion;
wherein the fastening portion is structurally configured to physically secure to the cable port without rotation of the body portion relative to the cable port;
wherein the resistor pin portion is structurally configured to contact the floating portion; and
wherein the resistor pin portion is structurally configured to contact a conductor aperture of the cable port to electrically terminate a cable conductor of the cable port via movement of the floating portion so as to mitigate noise introduced to a network to which the cable port is connected.

2. The termination arrangement of claim 1, wherein the biasing portion comprises a spring.

3. The termination arrangement of claim 1, wherein the resistor portion is positioned in a resistor recess of the floating portion.

4. The termination arrangement of claim 1, wherein the second retention portion of the floating portion comprises a ridge continuously extending around a periphery of the floating portion.

5. The termination arrangement of claim 1, wherein the first retention portion of the floating portion comprises a cantilevered protrusion continuously extending around a periphery of the floating portion.

6. The termination arrangement of claim 1, wherein the body portion comprises a protrusion that is structurally configured to contact the floating portion second retention portion to limit movement of the floating portion relative to the body portion.

7. The termination arrangement of claim 1, wherein the body portion is structurally configured to remain stationary during movement of the floating portion.

8. The termination arrangement of claim 1, wherein the respective cantilevered protrusions of the plurality of cantilevered protrusions are structurally configured to be flexible relative to one another and relative to the body portion.

9. The termination arrangement of claim 1, wherein the plurality of cantilevered protrusions are structurally configured to define a retention contour portion.

10. The termination arrangement of claim 9, wherein the retention contour portion comprises recesses into the respective cantilevered protrusions of the plurality of cantilevered protrusions.

11. The termination arrangement of claim 1, wherein the respective cantilevered protrusions of the plurality of cantilevered protrusions are structurally configured with separation gaps continuously extending from the body portion.

12. A termination arrangement structurally configured to electrically terminate a cable conductor so as to mitigate introduction of noise into a network, comprising:
a body portion;
a resistor portion structurally configured to be positioned within the body portion;
a floating portion structurally configured to be positioned within the body portion;
a fastening portion structurally configured to extend from the body portion;
wherein the floating portion is structurally configured to contact a biasing portion;
wherein the resistor portion is structurally configured to connect to the floating portion;
wherein the floating portion is structurally configured with a first retention portion and a second retention portion respectively arranged to limit movement of the floating portion within a floating cavity of the body portion; and
wherein the floating portion is structurally configured to move within the floating cavity portion in response to external force to eliminate noise introduced to the resistor portion so as to mitigate noise introduced to a network to which the termination arrangement is connected.

13. The coaxial termination arrangement of claim 12, wherein the body portion is structurally configured to be physically attached to a port portion of a network component.

14. The coaxial termination arrangement of claim 13, wherein a resistor pin portion attached to the resistor portion is structurally configured to fit within a cable port aperture.

15. The coaxial termination arrangement of claim 14, wherein the floating portion is structurally configured to apply pressure on the resistor portion to maintain the resistor pin portion in the cable port aperture.

16. The coaxial termination arrangement of claim 12, wherein the resistor portion has a continuous resistance of 75 ohms.

17. The coaxial termination arrangement of claim 12, wherein the resistor portion has a continuous resistance of 50 ohms.

18. The coaxial termination arrangement of claim 12, wherein the resistor pin portion is structurally configured to electrically contact a signal carrying conductor of a cable.

19. A termination arrangement structurally configured to electrically terminate a cable conductor so as to mitigate introduction of noise into a network, comprising:
a body portion;
a resistor portion structurally configured to be positioned within the body portion;
a floating portion structurally configured to be positioned within the body portion;
wherein the floating portion is structurally configured to contact a biasing portion;
wherein the resistor portion is structurally configured to connect to the floating portion; and
wherein the floating portion is structurally configured to move within a floating cavity portion in response to external force to eliminate noise introduced to the resistor portion so as to mitigate noise introduced to a network to which the termination arrangement is connected.

20. The male termination arrangement of claim 19, wherein the floating portion is structurally configured to move in response to the biasing portion to maintain the resistor portion in electrical contact with a cable conductor.

21. The male termination arrangement of claim 19, wherein the floating portion is structurally configured with a resistor recess portion shaped to center the resistor portion within the floating portion.

22. The male termination arrangement of claim 19, wherein the resistor portion is structurally configured to provide a constant resistance.
